(19) United States
(12) Patent Application Publication
(10) Pub. No.: US 2009/0009503 A1
(43) Pub. Date: Jan. 8, 2009

(54) LIQUID-CRYSTAL DISPLAY

(75) Inventor: Kenichi TAJIRI, Ichinomiya-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/143,122

(22) Filed: Jun. 20, 2008

(30) Foreign Application Priority Data
Jul. 4, 2007 (JP) 2007-176350

(51) Int. Cl. G06F 3/038

(52) U.S. Cl. 345/211; 345/87

(57) ABSTRACT

A liquid-crystal display includes a gate line, a gate driver supplying gate signals to the gate line, a source line, a source driver supplying source signals to the source line, a pixel electrode to which the source signals are applied via a pixel switching element connected to the source line, a liquid crystal disposed between the pixel electrode and a common electrode, a common electrode driver supplying common electrode signals to the common electrode, a capacitor disposed between the pixel electrode and a capacitor line, a driving circuit alternately changing the voltage level of the capacitor line between a first level and a second level, and a sequence control circuit. The sequence control circuit performs control such that the common electrode and the source line are short-circuited and supply of power to the source driver, the common electrode driver, and the driving circuit is cut off when a signal for turning off the power to the liquid-crystal display is detected, and that the voltage level of the pixel electrode is set to a ground level after the cutoff of the power supply by turning on the pixel switching element in accordance with a gate signal from the gate driver.

### BACKGROUND

1. Technical Field

The present invention relates to liquid-crystal displays, and in particular, relates to liquid-crystal displays capable of controlling sequences when the power supply is cut off.

2. Related Art

To date, methods using capacitor lines have been used for driving liquid-crystal displays. In these methods, capacitors are disposed between the capacitor lines and pixel electrodes, and the potentials of the pixel electrodes are changed in a positive or negative direction by changing the potentials of the capacitor lines after display signals are written in pixels. With this, the dynamic range of the display signals can be reduced, resulting in a low-consumption drive.

Power supply to such liquid-crystal displays is cut off after off-potentials (potentials for turning off the display operation by liquid crystals) are written in the pixels.

JP-A-2002-196358, for example, describes a liquid-crystal display driven by a method using capacitor lines.

However, in such liquid-crystal displays driven by the methods using the capacitor lines, charges can move to the pixel electrodes via the capacitors when the power supply is cut off, for example, in a sleep mode, and can lead to display failure.

### SUMMARY

An advantage of some aspects of the invention is to provide a liquid-crystal display including a gate line, a gate driver that supplies gate signals to the gate line, a source line, a source driver that supplies source signals to the source line, a pixel electrode to which the source signals are applied via a pixel switching element connected to the source line, a liquid crystal disposed between the pixel electrode and a common electrode, a common electrode driver that supplies common electrode signals to the common electrode, a capacitor disposed between the pixel electrode and a capacitor line, a driving circuit that alternately changes the voltage level of the capacitor line between a first level and a second level, and a sequence control circuit. The sequence control circuit performs control such that the common electrode and the source line are short-circuited and supply of power to the source driver, the common electrode driver, and the driving circuit is cut off when a signal for turning off the power to the liquid-crystal display is detected, and that the voltage level of the pixel electrode is set to a ground level after the cutoff of the power supply by turning on the pixel switching element in accordance with a gate signal from the gate driver.

In the liquid-crystal display driven by the method using the capacitor line according to the invention, the pixel electrode, the common electrode, and either end of the capacitor are set to a ground level when the power supply is cut off. With this, charge transfer is avoided, preventing display failure.

### BRIEF DESCRIPTION OF THE DRAWINGS

The invention will be described with reference to the accompanying drawings, wherein like numbers reference like elements.

FIG. 1 is a circuit diagram illustrating a liquid-crystal display according to an embodiment of the invention.

FIG. 2 illustrates the layout of pixels in the liquid-crystal display according to the embodiment of the invention.

FIG. 3 is a timing chart illustrating the sequence performed in the liquid-crystal display according to the embodiment of the invention when the power supply is cut off.

FIG. 4 is a circuit diagram illustrating the liquid-crystal display according to the embodiment of the invention,

FIG. 5 is a circuit diagram illustrating the liquid-crystal display according to the embodiment of the invention.

### DESCRIPTION OF EXEMPLARY EMBODIMENTS

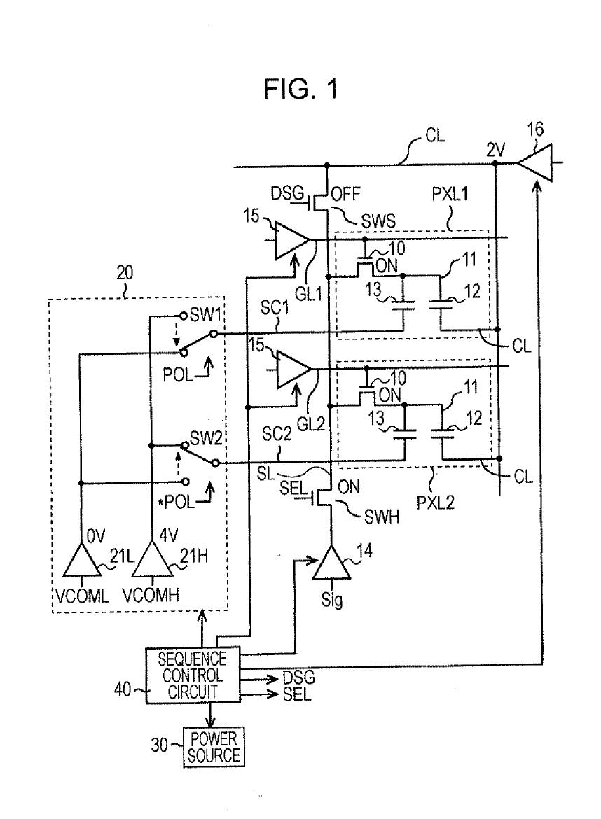

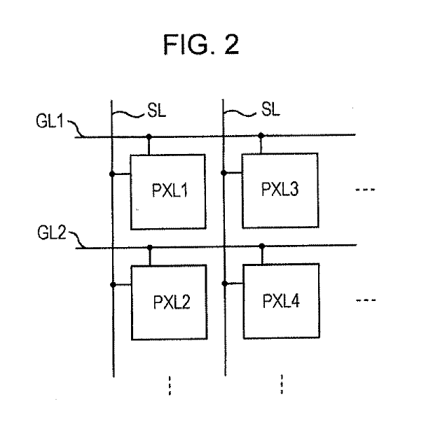

A liquid-crystal display according to an embodiment of the invention will now be described with reference to the drawings. As shown in FIG. 1, the liquid-crystal display includes a pixel PXL1 formed at a position corresponding to the intersection of a source line SL and a first gate line GL1 and a pixel PXL2 formed at a position corresponding to the intersection of the source line SL and a second gate line GL2. In FIG. 1, only two pixels PXL1 and PXL2 are shown. However, a plurality of pixels PXL1, PXL2, PXL3, PXL4, . . . form a matrix in an actual liquid-crystal display as shown in FIG. 2.

The pixels PXL1 and PXL2 each include a pixel transistor 10 (example of a pixel switching element of the invention) formed of an N-channel thin-film transistor (hereinafter referred to as TFT), a pixel electrode 11 connected to the drain of the pixel transistor 10, and a liquid crystal 12 disposed between the pixel electrode 11 and a common electrode CL. A first capacitor line SC1 is connected to the pixel PXL1 in the first row, and a capacitor 13 is disposed between the pixel electrode 11 in the pixel PXL1 and the first capacitor line SC1. Moreover, a second capacitor line SC2 is connected to the pixel PXL2 in the second row, and a capacitor 13 is disposed between the pixel electrode 11 in the pixel PXL2 and the second capacitor line SC2.

The sources of the pixel transistors 10 in the pixels PXL1 and PXL2 are connected to the source line SL. The gate of the pixel transistor 10 in the pixel PXL1 in the first row is connected to the first gate line GL1, and that of the pixel transistor 10 in the pixel PXL2 in the second row is connected to the second gate line GL2.

The liquid-crystal display further includes a source driver 14 that supplies source signals Sig (display signals) to the source line SL. The polarity of the source signals Sig is inverted with respect to a reference potential at a constant period, for example, at a horizontal period. A horizontal switching element SWH formed of an N-channel TFT is disposed between the source driver 14 and the source line SL, and supplies the source signals Sig from the source driver 14 to the source line SL when the horizontal switching element SWH is turned on in accordance with control signals.

The liquid-crystal display further includes gate drivers 15 that supply gate signals to the gate lines GL1 and GL2. The gate drivers 15 each include a DC-DC converter (not shown) for generating gate signals of a high level (for example, 8 V) for turning on the corresponding pixel transistor 10 and gate signals of a low level (for example, −4 V) for turning off the corresponding pixel transistor 10. The gate driver 15 in the first row outputs a signal to the first gate line GL1 during a horizontal period, and the gate driver 15 in the second row outputs a signal to the second gate line GL2 during the next horizontal period in one frame period. When the gate driver 15 in the first row outputs the signal to the first gate line GL1 during the horizontal period, the horizontal switching element SWH is turned on such that a source signal for the pixel corresponding to the first gate line GL1 is output. Subsequently, when the gate driver 15 in the second row outputs the signal to the second gate line GL2 during the next horizontal period, the horizontal switching element SWH is turned on such that a source signal for the pixel corresponding to the second gate line GL2 is output.

A switching element SWS formed of an N-channel TFT is disposed between the source line SL and the common electrode CL. When the power supply is cut off, this switching element SWS is turned on in accordance with control signals DSG so that the source line SL and the common electrode CL are short-circuited.

The liquid-crystal display further includes a common electrode driver 16 that supplies common electrode signals to the common electrode CL during normal operation. The common electrode signals can be, for example, a DC voltage of 2 V.

The liquid-crystal display further includes a driving circuit 20 that alternately supplies a high-level voltage VCOMH (for example, 4 V) and a low-level voltage VCOML (for example, 0 V) to the capacitor lines in each frame period. The driving circuit 20 includes a first capacitor driver 21H that outputs the high-level voltage VCONH, a second capacitor driver 21L that outputs the low-level voltage VCOML, a first polarity switching element SW1, and a second polarity switching element SW2.

The first polarity switching element SW1 switches in accordance with polarity selection signals POL such that the high-level voltage VCOMH output from the first capacitor driver 21H and the low-level voltage VCOML output from the second capacitor driver 21L are alternately output to the first capacitor line SC1. The second polarity switching element SW2 switches in accordance with polarity selection signals *POL (inverted signals of the polarity selection signals POL) in a manner complimentary to the first polarity switching element SW1 such that the high-level voltage VCOMH output from the first capacitor driver 21H and the low-level voltage VCOML output from the second capacitor driver 21L are alternately output to the second capacitor line SC2.

With this, the capacitor lines SC1 and SC2 adjacent to each other are driven such that the polarities thereof are opposite to each other (the voltage level of one capacitor line is high, and that of the other is low). Herein, a source voltage is supplied from a power source 30 to the source driver 14, the gate drivers 15, the common electrode driver 16, and the driving circuit 20. Moreover, although not shown, source voltages are supplied from other power sources to circuits other than those described above.

The liquid-crystal display further includes a sequence control circuit 40 that controls the sequence of the operations of the source driver 14, the gate drivers 15, the common electrode driver 16, the switching element SWS, the horizontal switching element SWH, the driving circuit 20, and the power source 3Q when the power supply is cut off. The sequence control circuit 40 starts sequence control when signals for turning off the power source 30 of the liquid-crystal display, for example, power-off commands or display-off commands are detected.

A writing operation during normal operation of the liquid-crystal display is as follows. Herein, a writing operation to the pixel PXL1 in the first row will be described. First, a high-level gate signal is output from the gate driver 15 in the first row to the first gate line GL1 during a horizontal period. With this, the pixel transistor 10 is turned on. At this moment, the switching element SWS is turned off, and the horizontal switching element SWH is turned on. When a source signal Sig is output from the source driver 14 to the source line SL, the source signal Sig is written in the pixel PXL1 via the pixel transistor 10 (pixel writing). That is, the source signal Sig is applied to the pixel electrode 11 via the pixel transistor 10 and retained by the capacitor 13.

Subsequently, when a low-level gate signal is output, the first polarity switching element SW1 in the driving circuit 20 is switched, and the voltage level of the first capacitor line SC1 is changed. That is, the voltage level of the first capacitor line SC1 is changed from the high-level voltage VCOMH to the low-level voltage VCOML, or from the low-level voltage VCOML to the high-level voltage VCOMH. With this, the voltage level of the pixel electrode 11 is changed from the voltage level written in the pixel in a positive or negative direction by action of capacitive coupling with the capacitor 13. For example, when the voltage level of the first capacitor line SC1 is changed from the high-level voltage VCOMH to the low-level voltage VCOML, the voltage level of the pixel electrode 11 is changed in the negative direction. With this, the liquid crystal 12 is optically controlled in accordance with the voltage level retained by the pixel electrode 11 so as to perform a display operation. By this driving method using the capacitor lines, the dynamic range of the source signals Sig can be reduced by an increase in voltage of the pixel electrode 11 due to the capacitive coupling, and a low-consumption drive can be realized.

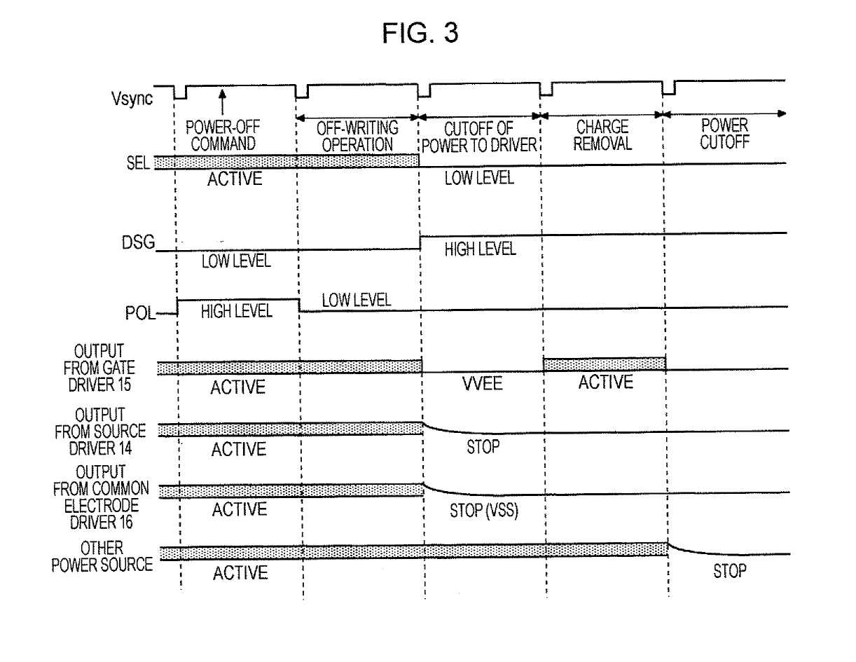

The sequence control performed by the sequence control circuit 40 when the power supply is cut off is a feature of the invention. This will be described with reference to a timing chart (FIG. 3) and circuit diagrams (FIGS. 1, 4, and 5). In FIG. 3, the hatched areas indicate active states, in which the signals can be high levels or low levels.

When a power-off command, for example, is detected as a signal for turning off the power source 30 of the liquid-crystal display, the level of the polarity selection signals POL is changed from high to low in synchronization with the next vertical synchronization signal Vsync. The switching element SWS is turned off in accordance with a low-level control signal DSG, and the source line SL and the common electrode CL are not connected to each other. The common electrode driver 16 outputs a voltage of 2 V as a common electrode signal.

The gate drivers 15 are activated in the same frame period. The pixel transistor 10 in the pixel PXL1 is turned on when a high-level gate signal is output to the first gate line GL1 during a horizontal period. Subsequently, the horizontal switching element SWE is turned on in accordance with a high-level control signal SEL. With this, a source signal Sig having a voltage level for performing a display-off operation, for example, a voltage level for displaying black is output from the source driver 14 to the source line SL, and the source signal Sig having the voltage level for performing the display-off operation is written in the pixel PXL1 via the pixel transistor 10 (off-writing operation).

Subsequently, the first polarity switching element SW1 is switched in accordance with the polarity selection signals POL, and the voltage level of the first capacitor line SC1 for the pixel PXL1 is changed from the high-level voltage VCONH to the low-level voltage VCOML. With this, the voltage level of the pixel electrode 11 is changed from the written voltage level in the negative direction by action of capacitive coupling with the capacitor 13, and the liquid crystal 12 is optically controlled in accordance with the voltage level retained by the pixel electrode 11 so as to perform a display-off operation. The off-writing operation to the pixel PXL2 is substantially the same as that to the pixel PXL1 except that the voltage level of the second capacitor line SC2 is changed from low to high after the writing operation.

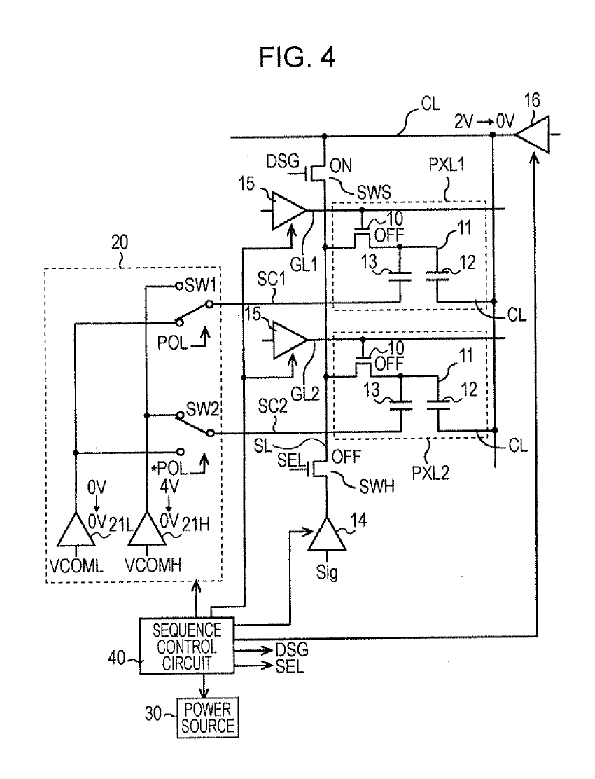

Subsequently, the level of the control signals DSG is changed to high in synchronization with the next vertical synchronization signal Vsync, that is, in the next frame period. With this, the switching element SWS is turned on as shown in FIG. 4, and the source line SL and the common electrode CL are short-circuited. Moreover, the level of the control signals SEL is changed to low. With this, the horizontal switching element SWH is turned off, and the source driver 14 is electrically disconnected from the source line SL.

When the supply of the source voltage from the power source 30 is cut off, the:operation of the common electrode driver 16 is stopped, and the output is changed from 2 V to 0 V (ground level). With this, the common electrode CL is set to 0 V, and thus the source line SL is also set to 0 V. Moreover, the operations of the source driver 14 and the capacitor drivers 21H and 21L are also stopped in the same frame period due to the cutoff of the supply of the source voltage from the power source 30. With this, the voltage level of the capacitor lines SC1 and SC2 is set to 0 V. Moreover, low-level gate signals are output from the gate drivers 15, and the voltage levels of the gate lines GL1 and GL2 are set to low.

In this state, both the source line SL and the common electrode CL are set to 0 V. However, when charges are moved to the pixel electrodes 11 via the capacitors 13, potential differences occur at either end of the liquid crystals 12, that is, between the pixel electrodes 11 and the common electrode CL. This causes display failure.

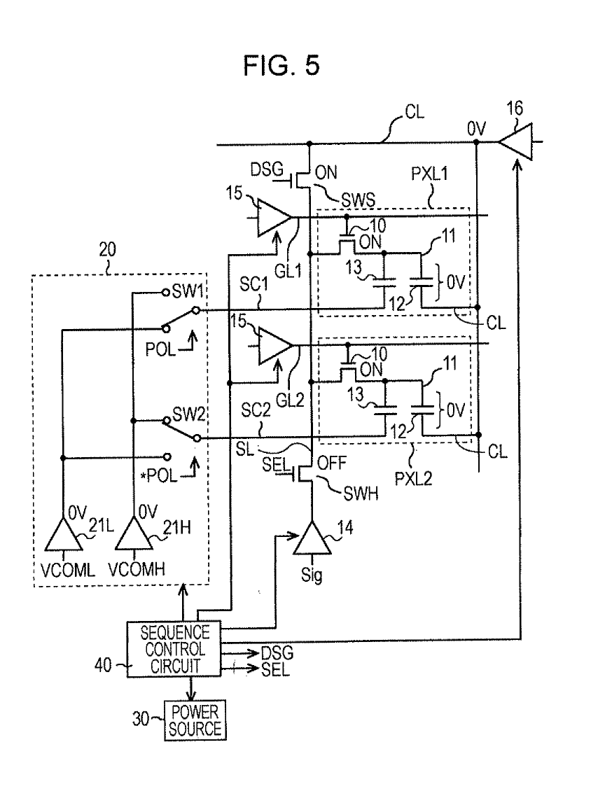

Accordingly, an operation for removing the charges moved to the pixel electrodes 11 is performed. When a high-level gate signal is output from the gate driver 15 in the first row to the first gate line GL1 during a horizontal period in the next frame period, the pixel transistor 10 in the pixel PXL1 is turned on as shown in FIG. 5. With this, the voltage level of the source line SL (0 V) is written in the pixel PXL1, and the voltage level of the pixel electrode 11 in the pixel PXL1 is set to 0 V. That is, the charges moved to the pixel electrode 11 are removed. The same applies to the pixel PXL2. When a high-level gate signal is output from the gate driver 15 in the second row to the second gate line GL2 during the next horizontal period, the pixel transistor 10 in the pixel PXL2 is turned on. With this, the voltage level of the pixel electrode 11 in the pixel PXL2 is set to 0 V. In this manner, charges moved to the pixel electrodes in all the pixels are removed.

The operation of the gate drivers 15 is stopped in synchronization with the next vertical synchronization signal Vsync, that is, in the next frame period due to the cutoff of the supply of the source voltage from the power source 30. After this frame period, the operations of other circuits (not shown) are also stopped due to cutoff of supply of source voltages from other power sources (not shown).

In the above-described liquid-crystal display, the voltage levels of the pixel electrodes 11, the common electrode CL, and either end of the capacitors 13 are set to 0 V when the power supply is cut off. Therefore, charge transfer can be avoided, preventing display failure.

The invention is not limited to the above-described embodiment, and modifications and improvements are possible within the scope of the invention. For example, the off-writing operation is not necessarily performed in the above-described embodiment, and can be omitted. In this case, when a power-off command is detected, the operations of the common electrode driver 16, the source driver 14, and the capacitor drivers 21H and 21L constituting the driving circuit 20 are stopped in synchronization with the next vertical synchronization signal Vsync, and the subsequent sequence control is performed.

What is claimed is:

1. A liquid-crystal display comprising:
a gate line;
a gate driver that supplies gate signals to the gate line;
a source line;
a source driver that supplies source signals to the source line;
a pixel electrode to which the source signals are applied via a pixel switching element connected to the source line;
a liquid crystal disposed between the pixel electrode and a common electrode;
a common electrode driver that supplies common electrode signals to the common electrode;
a capacitor disposed between the pixel electrode and a capacitor line;
a driving circuit that alternately changes the voltage level of the capacitor line between a first level and a second level; and
a sequence control circuit, wherein
the sequence control circuit performs control such that the common electrode and the source line are short-circuited and supply of power to the source driver, the common electrode driver, and the driving circuit is cut off when a signal for turning off the power to the liquid-crystal display is detected, and that the voltage level of the pixel electrode is set to a ground level after the cutoff of the power supply by turning on the pixel switching element in accordance with a gate signal from the gate driver.

2. The liquid-crystal display according to claim 1, wherein the sequence control circuit performs control such that an off-potential for turning off the display operation by the liquid crystal is written in the pixel electrode via the pixel switching element before the cutoff of the power supply when the signal for turning off the power to the liquid-crystal display is detected.

3. The liquid-crystal display according to claim 1, wherein the sequence control circuit performs control such that the common electrode and the source line are short-circuited and the supply of power to the source driver, the common electrode driver, and the driving circuit is cut off in one frame period, and that the voltage level of the pixel electrode is set to the ground level by turning on the pixel switching element in accordance with the gate signal from the gate driver in the next frame period.

4. The liquid-crystal display according to claim 1, further comprising:
a switching element disposed between the source line and the common electrode, wherein
the sequence control circuit short-circuits the source line and the common electrode by turning on the switching element.
